(19) United States
(12) Patent Application Publication
(10) Pub. No.: US 2007/0174212 A1
(43) Pub. Date: Jul. 26, 2007

(54) Method, system, and computer program product for providing location-specific transaction services

(75) Inventors: Gregory R. Hintermeister, Rochester, MN (US); Bryan M. Logan, Rochester, MN (US); Timothy C. Mossing, Rochester, MN (US)

Correspondence Address: CANTOR COLBURN LLP - IBM ROCHESTER DIVISION, 55 GRIFFIN ROAD SOUTH, BLOOMFIELD, CT, 06002, US

(73) Assignee: INTERNATIONAL BUSINESS MACHINES CORPORATION, ARMONK, NY (US)

(21) Appl. No.: 11/338,332

(22) Filed: Jan. 24, 2006

(51) Int. Cl. G06Q 99/00; G06G 7/00

(52) U.S. Cl. 705/400; 705/1

(57) ABSTRACT

A method, system, and computer program product for implementing location-specific transaction services by a dispensing device situated in a defined geographic community are provided. The method includes providing location-specific information, including costs for items specific to the defined geographic community, and which are representative of a cost of living for the defined geographic community. The location-specific information is presented in a currency and language native to a requester of the location-specific information, as well as in a currency native to the defined geographic community. The location-specific information also includes a summation of costs for items selected by the requester, which is presented in a currency and language native to the requester and in a currency native to the defined geographic community. The method also includes executing a transaction between a financial institution and the requester based upon the summation of costs.

### TRADEMARKS

IBM® is a registered trademark of International Business Machines Corporation, Armonk, N.Y., U.S.A. Other names used herein may be registered trademarks, trademarks or product names of International Business Machines Corporation or other companies.

### BACKGROUND OF THE INVENTION

1. Field of the invention

This invention relates generally to transactional services and, more particularly, to a method, system, and computer program product for providing location-specific transaction services.

2. Description of background

There are many considerations one must take when traveling away from home on business or for pleasure. There may be different languages spoken, variations in the cost of living, different currencies used, and variations in monetary exchange rates, to name a few. Because of this, it is oftentimes difficult to estimate how much money one might need during any given day of the trip. These considerations may be further aggravated when factoring in the day-to-day changes that inevitably occur with the costs of living and exchange rates.

What is needed, therefore, is a way to provide location-specific information and services that are customized to the needs of an individual, and which factor in changes to the information over time.

### SUMMARY OF THE INVENTION

The shortcomings of the prior art are overcome and additional advantages are provided through a method, system, and computer program product for providing location-specific transaction services by a dispensing device situated in a defined geographic community. The method includes providing location-specific information, including costs for items specific to the defined geographic community, and which are representative of a cost of living for the defined geographic community. The location-specific information is presented in a currency and language native to a requester of the location-specific information, as well as in a currency native to the defined geographic community. The location-specific information also includes a summation of costs for items selected by the requester, which is presented in a currency and language native to the requester and in a currency native to the defined geographic community. The method also includes executing a transaction between a financial institution and the requester based upon the summation of costs.

System and computer program products corresponding to the above-summarized method are also described and claimed herein.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### Technical Effects

As a result of the summarized invention, technically we have achieved a solution, which will allow a user to receive customized, location-specific information and financial transaction services.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 illustrates one example of a system upon which the location-specific transaction services may be implemented in an exemplary embodiment;

FIG. 2 is a flow diagram describing a process for implementing the location-specific transaction services in an exemplary embodiment; and

FIG. 3 illustrates one example of a user interface screen that depicts sample menu options available through the location-specific transaction services in an exemplary embodiment.

The detailed description explains the exemplary embodiments of the invention, together with advantages and features, by way of example with reference to the drawings.

### DETAILED DESCRIPTION OF THE EXEMPLARY EMBODIMENTS

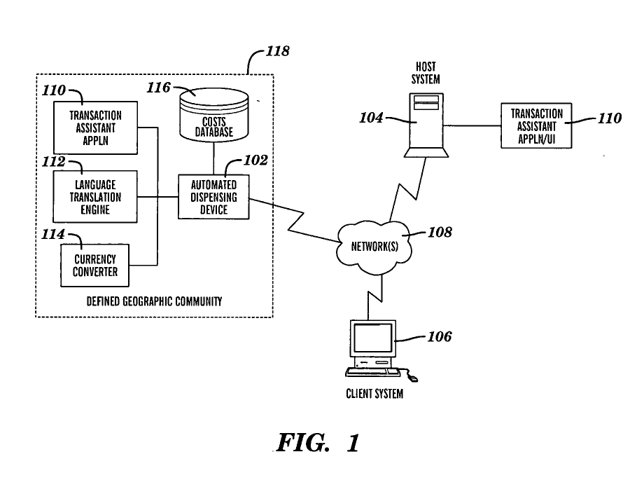

Turning now to FIG. 1, a system upon which the location-specific transaction services may be implemented in an exemplary embodiment will now be described. The system includes automated dispensing device 102 (also referred to herein as dispensing device), host system 104, and client system 106, communicatively coupled to one or more network(s) 108. Automated dispensing device 102 may comprise any device capable of dispensing location-specific items of value to individuals, such as cash, information, event tickets, reservation confirmations, coupons, maps, directions, language translation guides, guides to local customs, and stamps, to name a few.

In an exemplary embodiment, automated dispensing device 102 incorporates some of the features and functionality associated with automated teller machines (ATMs), kiosks, or other similar types of machinery (e.g., input screen/keys, output elements including a display screen, network connectivity, processor, software, etc.). While only one automated dispensing device 102 is illustrated in the system diagram of FIG. 1, it will be appreciated that any number of these devices may be employed via the location-specific transaction services described herein. Moreover, for illustrative purposes, each automated dispensing device is situated in a separate geographic location and services the particular geographic location in which it is situated. In exemplary embodiments, a series of defined geographic communities are established, each of which is serviced by a particular dispensing device. The geographic communities may be defined by any means, e.g., by city, province, state, county, country, language spoken, natural or artificial boundaries, etc. As shown in FIG. 1, a sample defined geographic community 118 is serviced by dispensing device 102.

The dispensing device 102 executes applications for implementing the location-specific transaction services, such as a transaction assistant application 110, a language translation engine 112, and currency converter 114. The transaction assistant application 110 provides logic for processing requests for location-specific information, including searching its databases for cost items, calculating total costs, and utilizing other applications (e.g., language translation engine 112 and currency converter 114) as will be described further herein.

Host system 104 may be implemented by a provider of the location-specific transaction services. For example, host system 104 may be affiliated with a particular financial institution, which provides location-specific transaction services to its customers, and alternatively, to both customers and non-customers for a fee. In alternative exemplary embodiments, the location-specific transaction services may be implemented by an application service provider working in cooperation with various financial institutions, community groups, and/or or business enterprises to provide these services. Host system 104 executes computer instructions for performing various services (e.g., Web-based financial transaction services to customers and defined geographic communities, database creation, maintenance and services to customers (whereby host system is an application service provider), currency conversion and language services, etc.).

According to an exemplary embodiment, the host system 104 creates databases of cost information (e.g., cost of living information for items and services specific to the defined geographic community), event information, discount information, etc., and provides maintenance of these databases including updates as the information changes over time (e.g., changes to rates or costs based upon cost of living changes, discontinued promotions, new promotions, new or discontinued items, etc.). These and other features of the location-specific transaction services may be implemented by an application executing on the host system 104, referred to as a transaction assistant application 110. The transaction assistant application 110 also includes a user interface component that enables subscribing entities (e.g., users of client system 106) to configure customized options available via the transaction assistant application 110. These and other features of the transaction assistant application 110 and the user interface will be described further herein.

Client system 106 may be operated by a customer of the location-specific transaction services. Client system 106 may be implemented using a general-purpose computer executing a computer program for carrying out the processes described herein. The client system 106 may be a personal computer (e.g., a lap top, a personal digital assistant) or host-attached terminal. If the client system 106 is a personal computer, the processing described herein may be shared by client system 106 and the host system 104 (e.g., by providing an applet to the client system 106). In exemplary embodiments, the client system 106 operator provides actual cost information for items and/or services offered within a defined geographic community (e.g., 118) to the host system 104 for updating to an associated dispensing device (e.g., device 102). For example, client system 106 may be operated by an individual of a concert hall located in the defined geographic community 118. The operator may enter costs of an event scheduled at the concert hall, such as ticket seating prices and availability. In alternative exemplary embodiments, this information may be automatically electronically acquired by the respective dispensing device 102 without operator involvement by, e.g., linking the dispensing device to a processor at the concert hall via network(s) 108. In another example, client system 106 may be a hotel, restaurant, or other enterprise situated in the defined geographic community 118.

In alternative embodiments, client system 106 is in direct communication with a dispensing device, such that information and/or updates are directly provided between the client system 106 and the respective dispensing device without host system 104 involvement. In yet further embodiments, the client system 106 may be operated by a representative of the host system 104 that is responsible for maintaining current costs of items stored in a respective database 116 (e.g., averaged costs of items/services based upon costs of living of the defined geographic community).

In yet further embodiments, client system 106 may be implemented by an end-user customer of the transaction services. In this embodiment, the end-user customer may access client system 106 and conduct a portion of the transaction services (via, e.g., a website of the host system 104) in advance of visiting the dispensing device. This embodiment is described further herein.

While only one client system 106 is shown in the system of FIG. 1, it will be understood that numerous client systems may be employed, each operated by a different enterprise and/or customer associated with the particular defined geographic community (e.g., 118).

The network(s) 108 may be any type of known networks including, but not limited to, a wide area network (WAN), a local area network (LAN), a global network (e.g. Internet), a virtual private network (VPN), an intranet, or a combination thereof. The network(s) 108 may be implemented using wireless network technologies or any kind of physical network implementation known in the art. Client system 106 and/or dispensing device 102 may be coupled to the host system 104 through multiple networks (e.g., intranet and Internet) so that not all client systems (e.g., client system 106) and/or dispensing devices 102 are coupled to the host system 104 through the same network. One or more of client systems and/or dispensing devices 102 and the host system 104 may be connected to the network(s) 108 in a wireless fashion.

According to an exemplary embodiment, automated dispensing device 102 is in communication with a database 116 within one or more storage devices. Storage device 116 stores a variety of information including, e.g., databases of cost information specific to the defined geographic location in which the respective dispensing device resides. Storage device 116 may be implemented using a variety of devices for storing electronic information. It will be understood that the storage device 116 may be implemented using memory contained in the automated dispensing device 102 or may be a separate physical device. Further, although a single storage device is shown for ease of illustration, it should be appreciated that more than two storage devices may be used. The storage device 116 is logically addressable as a consolidated data source across a distributed environment that includes network(s) 108. Information stored in the storage device 116 may be retrieved and manipulated via the host system 104.

The host system 104 depicted in FIG. 1 may be implemented using one or more servers operating in response to a computer program stored in a storage medium accessible by the server(s). The host system 104 may operate as a network server (e.g., a web server) to communicate with the client system 106 and dispensing device 102. The host system 104 handles sending and receiving information to and from the client system 106 and dispensing device 102 and can perform associated tasks.

The host system 104 may also operate as an application server. As indicated above, the host system 104 executes the transaction assistant application 110 for providing location-specific transaction services. Processing may be shared by the client system 106 or dispensing device 102 and the host system 104 by providing an application (e.g., Java applet) to the client system 106 or dispensing device 102. Alternatively, the client system 106 or dispensing device 102 can include stand-alone software applications for performing a portion of the processing described herein. As previously described, it is understood that separate servers may be utilized to implement the network server functions and the application server functions.

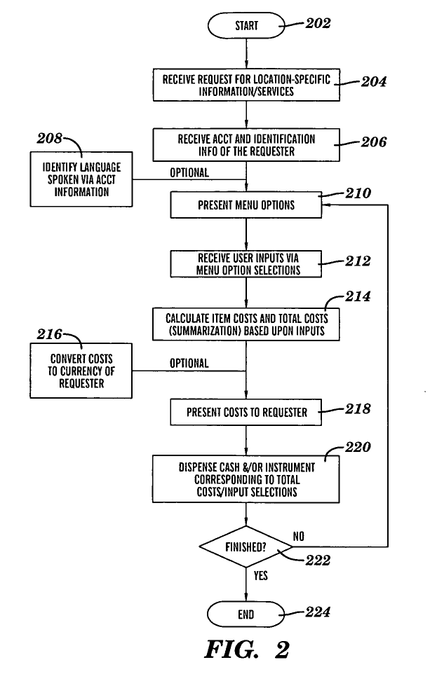

Turning now to FIG. 2, a process for implementing the location-specific transaction services will now be described in accordance with an exemplary embodiment. The process starts at step 202 whereby a request for location-specific services is received at the dispensing device 102 at step 204. In an exemplary embodiment, this information is acquired when the requester scans or submits a card that includes the requester's account information (e.g., name, account number, institution identification, etc.). The transaction assistant application 110 verifies the identity of the requester (e.g., via a password entered at the dispensing device 102) and also identifies the financial institution for which the requester has an account (e.g., via the account and financial institution identification) at step 206.

In alternative exemplary embodiments, the transaction assistant application 110 identifies a primary language spoken by the requester via, e.g., the location of the financial institution at step 208. For example, the financial institution is likely to be in the country in which the requester resides. Alternatively, this information may be provided by an option selected by the requester on a display screen of the dispensing device 102.

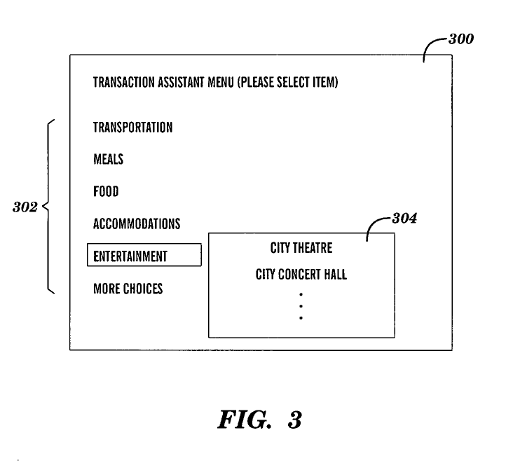

At step 210, the transaction assistant application 110 presents a menu screen and options in the language spoken by the requester via language translation engine 112, a sample of which is shown in FIG. 3. The menu options 302 shown in the user interface screen 300 of FIG. 3 include TRANSPORTATION (e.g., taxi rates, bus rates, train rates, subway rates, airline rates, ferry rates, etc.), MEALS (e.g., averaged costs for breakfast in the defined geographic community 118, actual costs of a particular restaurant menu item, etc.), FOOD, ACCOMMODATIONS (e.g., averaged costs for a hotel room, actual costs of reserving a room at a particular hotel, etc.), ENTERTAINMENT (e.g., events such as a concert hall, theatre production, theme park, etc.), and MORE CHOICES (e.g., directions, maps, mini translation guide, guide of local customs or behaviors, coupons, stamps, etc.).

At step 212, the dispensing device receives user inputs to the options. For example, as shown in the user interface screen 300 of FIG. 3, the requester has selected entertainment. This causes a subwindow 304 to be presented to the requester with specific options. At step 214, the transaction assistant application 110 calculates the costs of items selected by the requester, as well as a summation of the costs for items selected.

In alternative exemplary embodiments, the itemized and total costs are converted to the currency of the requester at step 216 via the currency converter 114. The currency converter identifies the currency of the requester based upon, e.g., the origin of the financial institution associated with the requester's account as perceived by the account information provided by the requester. The individual costs of items, as well as the total costs (i.e., summarization of costs) are presented to the requester in both the currency of the defined geographic community 118 and the currency native to the requester via, e.g., the display screen of dispensing device 102 at step 218. The requester is presented with additional options, such as approving transaction or canceling the transaction. For example, if the items selected by the requester include the costs of three meals, the requester is presented with the option of withdrawing an amount of money commensurate to the total costs for the three meals calculated by the transaction assistant application 110. If the requester selected theatre tickets, the requester may be presented with the option of purchasing the tickets, reserving the tickets, or withdrawing an amount of money to purchase the tickets.

At step 220, the dispensing device 102 dispenses one of cash, an instrument, a document, stamps, etc., based upon the requester's selections. For example, the instrument may be admission tickets if the requester selects the option to purchase the tickets rather than withdraw a cash amount to pay for the tickets. The documents may be a reservation confirmation, a receipt of purchase, a map, coupon, directions to an event, etc. The documents may also be a language translation guide and/or a guide to the local customs. The transaction assistant application 110 may be configured to provide documents that directly correspond to the selected items. For example, if the requester selects an item relating to a restaurant, the dispensing device 102 may present a mini language translation guide with terms directed to dining activities (e.g., terms for water, wine, coffee, fish; or common questions such as “where is the restroom”). Likewise, a customs guide presented might include local customs addressing restaurant behavior. At step 222, it is determined whether the transaction is complete. If not, the process returns to step 210. Otherwise, the process ends at step 224.

In alternative embodiments, the transaction assistant application 110 may be configured to dispense cash in a denomination commensurate with the selected items. For example, if the requester selects tolls, the dispensing device 102 may provide cash in a denomination that reflects the costs of the tolls (e.g., quarters, small bills, etc.).

As indicated above, the transaction assistant application 110 may provide a website that enables an end-user to conduct a portion of the transaction services in advance of frequenting the dispensing device. For example, the end user may access the website of host system 104 and be presented with a user interface screen similar to that shown in FIG. 3. The end user makes the selections and, at a future time, completes the transaction by visiting the dispensing device 102, entering account/PIN information, and receiving the instrument and/or cash.

In yet further embodiments, the transaction assistant application 110 may be configured for use in a geographic location close the end user's home. The transaction assistant 110 may provide the end user with expanded ATM services using, via e.g., multiple PINs created by the end user for such purpose. For example, the end user may enter one PIN for executing a repetitive transaction, so that the execution of the transaction is expedited, i.e., the user does not need to re-enter all of the details of the transaction but only the PIN itself.

The capabilities of the present invention can be implemented in software, firmware, hardware or some combination thereof.

As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

The flow diagram depicted herein is just an example. There may be many variations to this diagram or the steps (or operations) described therein without departing from the spirit of the invention. For instance, the steps may be performed in a differing order, or steps may be added, deleted or modified. All of these variations are considered a part of the claimed invention.

While the exemplary embodiments to the invention have been described, it will be understood that those skilled in the art, both now and in the future, may make various improvements and enhancements which fall within the scope of the claims which follow. These claims should be construed to maintain the proper protection for the invention first described.

What is claimed is:

1. A method for providing location-specific transaction services by a dispensing device situated in a defined geographic community, the method comprising:
providing location-specific information, comprising:
costs for items specific to the defined geographic community, the costs for items representative of a cost of living for the defined geographic community and presented in a currency and language native to a requester of the location-specific information and in a currency native to the defined geographic community; and
a summation of costs for items selected by the requester, the summation of costs presented in a currency and language native to the requester and in a currency native to the defined geographic community; and
executing a transaction between a financial institution and the requester based upon the summation of costs, the requester having an account with the financial institution.

2. The method of claim 1, wherein the costs for items include averaged costs, the items including at least one of:
taxi service rates;
hotel rates;
meal rates;
toll fees; and
estimated gratuities;
wherein the executing a transaction includes dispensing a cash amount corresponding to the summation of costs.

3. The method of claim 2, wherein the dispensing a cash amount includes dispensing cash in a denomination corresponding to the items selected by the requester.

4. The method of claim 1, wherein the costs for items include actual costs, the items including at least one of:
an event;
menu items at a restaurant;
a hotel reservation;
informational document; and
stamps;
wherein the executing a transaction includes dispensing at least one of a cash amount and an instrument of value corresponding to the summation of costs, the instrument of value including at least one of:
an admission ticket for the event;
a reservation confirmation;
a discounted coupon; and
stamps.

5. The method of claim 4, wherein the informational document further includes at least one of:
directions to at least one of the event, restaurant, and hotel;
a translation guide containing translations of terms specific to the selected items;
a guide of local customs associated with the selected items; and
a map of the defined geographic community.

6. The method of claim 4, wherein the discounted coupon is for an item or event in close geographic proximity to the selected items.

7. The method of claim 1, wherein the dispensing device services the defined geographic community, the defined geographic community defined by at least one of:
a city;
a province;
a state;
a county;
a country;
a language spoken;
natural boundary; and
artificial boundary.

8. A dispensing device situated in a defined geographic community for providing location-specific transaction services, the dispensing device comprising:
an input element for receiving a request for location-specific information;
an output element;
a display element;
a link to a network; and
a processor executing applications including a transaction assistant application, a currency converter, and a translation engine, the applications providing location-specific information in response to the request via at least one of the display and the output element, the location-specific information comprising:
costs for items specific to the defined geographic community, the costs for items representative of a cost of living for the defined geographic community and presented in a currency and a language native to a requester of the location-specific information and in a currency native to the defined geographic community; and
a summation of costs for items selected by the requester, the summation of costs presented in a currency and language native to the requester and in a currency native to the defined geographic community;
wherein the dispensing device executes a transaction between a financial institution and the requester via the network link and output element based upon the summation of costs, the requester having an account with the financial institution.

9. The dispensing device of claim 8, wherein the costs for items include averaged costs, the items including at least one of:
taxi service rates;
hotel rates;
toll fees;
meal rates; and
estimated gratuities;
wherein executing the transaction includes dispensing a cash amount corresponding to the summation of costs via the output element; and
wherein further, the dispensing a cash amount includes dispensing cash in a denomination corresponding to the items selected by the requester.

10. The dispensing device of claim 8, wherein the network link includes a communication link to at least one of a hotel, event ticket seller, restaurant, and financial institution, and wherein further, the costs for items include actual costs, the items including at least one of:
an event;
menu items at a restaurant;
a hotel reservation; and
stamps;
wherein executing the transaction includes dispensing at least one of a cash amount and an instrument of value corresponding to the summation of costs via the output element, the instrument of value including at least one of:
an admission ticket for the event;
a reservation confirmation;
a discounted coupon; and
stamps.

11. The dispensing device of claim 10, wherein the location-specific information further includes at least one of:
directions to at least one of the event, restaurant, and hotel; and
a translation guide containing translations of terms specific to the selected items;
a guide of local customs associated with the selected items; and
a map of the defined geographic community.

12. The dispensing device of claim 10, wherein the discounted coupon is for an item or event in close geographic proximity to the selected items.

13. The dispensing device of claim 8, wherein the dispensing device services the defined geographic community, the defined geographic community defined by at least one of:
a city;
a province;
a state;
a county;
a country;
a language spoken;
natural boundary; and
artificial boundary.

14. A computer program product for providing location-specific transaction services by a dispensing device situated in a defined geographic community, the computer program device including instructions for implementing a method comprising:
providing location-specific information, comprising:
costs for items specific to the defined geographic community, the costs for items representative of a cost of living for the defined geographic community and presented in a currency and language native to a requester of the location-specific information and in a currency native to the defined geographic community; and
a summation of costs for items selected by the requester, the summation of costs presented in a currency and language native to the requester and in a currency native to the defined geographic community; and
executing a transaction between a financial institution and the requester based upon the summation of costs, the requester having an account with the financial institution.

15. The computer program product of claim 14, wherein the costs for items include averaged costs, the items including at least one of:
taxi service rates;
hotel rates;
meal rates;
toll fees; and
estimated gratuities;
wherein the executing a transaction includes dispensing a cash amount corresponding to the summation of costs.

16. The computer program device of claim 15, wherein the dispensing a cash amount includes dispensing cash in a denomination corresponding to the items selected by the requester.

17. The computer program device of claim 14, wherein the costs for items include actual costs, the items including at least one of:
an event;
menu items at a restaurant;
toll fees;
a hotel reservation; and
stamps;
wherein the executing a transaction includes dispensing at least one of a cash amount and an instrument of value corresponding to the summation of costs, the instrument of value including at least one of:
an admission ticket for the event;
a reservation confirmation;
a discounted coupon; and
stamps.

18. The computer program product of claim 17, wherein the informational document further includes at least one of:
directions to at least one of the event, restaurant, and hotel;
a translation guide containing translations of terms specific to the selected items;
a guide of local customs associated with the selected items; and
a map of the defined geographic community.

19. The computer program product of claim 17, wherein the discounted coupon is for an item or event in close geographic proximity to the selected items.

20. The computer program product of claim 14, wherein the dispensing device services the defined geographic community, the defined geographic community defined by at least one of:
a city;
a province;
a state;
a county;
a country;
a language spoken;
natural boundary; and
artificial boundary.
